(19) United States
(12) Patent Application Publication
(10) Pub. No.: US 2010/0158232 A1
(43) Pub. Date: Jun. 24, 2010

(54) ACCESSING RECORDED CONFERENCE CONTENT

(75) Inventor: Dany Sylvain, Gatineau (CA)

Correspondence Address: WITHROW & TERRANOVA, P.L.L.C., 100 REGENCY FOREST DRIVE, SUITE 160, CARY, NC, 27518, US

(73) Assignee: Nortel Networks Limited, St. Laurent (CA)

(21) Appl. No.: 12/343,256

(22) Filed: Dec. 23, 2008

(51) Int. Cl. H04M 3/56

(52) U.S. Cl. 379/202.01

(57) ABSTRACT

The present invention provides participants in a conference and any other authorized users access to recorded content from the conference. In one embodiment, the conference output is continuously buffered to provide the recorded content as the conference progresses. At any time while the conference is in progress, a conference participant or other authorized user may access the recorded content to review the audio or other media information that has been recorded so far in the recorded content. In another embodiment, after the conference is over, the recorded content may be archived and made accessible to the conference participants and others via the conference system, which will keep track of the location of the recorded content and conference with which it is associated.

### FIELD OF THE INVENTION

The present invention relates to conference bridges, and in particular to accessing recorded conference content.

### BACKGROUND OF THE INVENTION

With the proliferation of audio and video conferencing, it is becoming more common for participants to record audio or video conferences for subsequent review. With properly equipped conference bridges, the conference audio, and perhaps any associated video, may be recorded and either stored as recorded content in a defined storage location or emailed to a specified participant after the conference is concluded. When stored in a defined storage location, at least some of the conference participants will not have direct access to or be readily able to ascertain the defined storage location. When email is used, not all of the participants are generally sent the recorded content, and given the size of the files associated with the recorded content, extensive use of email to share the recorded content results in inefficient use of the email system. As such, there is a need for a more efficient technique for gaining access to recorded content of audio and video conferences.

Although techniques exist to record audio and video conferences, the resulting recorded content is only available after the conference has concluded. Latecomers to the conference either need to interrupt the conference to rehash what has been covered or simply miss out on that portion of the conference that occurs before their arrival. Accordingly, in addition to a need for an efficient technique to gain access to recorded content for conferences, there is a further need for a technique to readily gain access to recorded content for a conference while the conference is still in progress.

### SUMMARY OF THE INVENTION

The present invention provides participants in a conference and any other authorized users access to recorded content from the conference. The recorded content may include the recorded audio content for the conference, and if available, any associated video content, messages from associated messaging exchanges, white board captures, document pointing histories, and application sharing information. In essence, the recorded content represents all or a portion of the various media and application information that is shared among conference participants during the conference. A conference system will facilitate the audio portion and any other media aspects for the conference and record the media information that represents the conference output as the recorded content. The conference output may be recorded automatically or in response to input from the conference chairperson or other participant.

In one embodiment, the conference output is continuously buffered to provide the recorded content as the conference progresses. At any time while the conference is in progress, a conference participant or other authorized user may access the recorded content to review the audio or other media information that has been recorded so far in the recorded content. Access to the recorded content may also be initiated by selecting a link that is provided to the conference participants via their communication terminals. In another embodiment, after the conference is over, the recorded content may be archived and made accessible to the conference participants and others via the conference system, which will keep track of the location of the recorded content and conference with which it is associated. In embodiments where the conference participant used a designated link to effectively join the conference, the conference participant may be able to readily access the recorded content by selecting the same link that was previously used to initiate the audio and other media sessions that are necessary for the conference. In other embodiments, the conference participant may be able to readily access the recorded content by selecting a link dedicated for this purpose.

In yet another embodiment, the audio portion of the recorded content may be processed such that any speech content is transcribed to corresponding text, which is searchable by anyone who has access to the text. The transcribed text may be accessed and searched in any manner. Access or searching may be enabled by using the same or different link that was used to gain access to the conference.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIGS. 2A through 2C illustrate a communication flow for an exemplary click-to-call process according to one embodiment of the present invention.

FIGS. 3A illustrates a calendar entry for the communication flow of FIGS. 2A-2C.

FIGS. 3B through 3E illustrate web pages provided to a user in association with the communication flow of FIGS. 2A-2C.

FIG. 4 is a communication flow illustrating providing a user access to recorded content of a conference while the conference is in progress according to one embodiment of the present invention.

FIGS. 5A and 5B illustrate web pages that are provided to the user in association with the communication flow of FIG. 4.

FIGS. 6A and 6B are a communication flow illustrating providing a user access to recorded content of a conference after the conference is over according to one embodiment of the present invention.

FIGS. 7A and 7B illustrate web pages provided to the user in association with the communication flow of FIGS. 6A-6B.

FIG. 8 illustrates a web page provided to a user in association with a text-based search of transcribed audio content for a conference according to one embodiment of the present invention.

FIG. 9 is a block representation of a conference server according to one embodiment of the present invention.

FIG. 10 is a block representation of a conference bridge according to one embodiment of the present invention.

FIG. 11 is a block representation of a service node according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention provides participants in a conference and any other authorized users access to recorded content from the conference. The recorded content may include the recorded audio content for the conference, and if available, any associated recorded video content, messages from associated messaging exchanges, white board captures, document pointing histories, and application sharing information. In essence, the recorded content represents all or a portion of the various media and application information that is shared among conference participants during the conference. A conference system will facilitate the audio and any other media aspects for the conference and record the media information that represents the conference output as the recorded content. The conference output may be recorded automatically or in response to input from the conference chairperson or other participant.

In one embodiment, the conference output is continuously buffered to provide the recorded content as the conference progresses. As such, the recorded content is dynamically and continuously being updated with the current conference output. At any time while the conference is in progress, a conference participant or other authorized user may access the recorded content to review the audio or other media information that has been recorded so far in the recorded content. This is particularly beneficial when the conference participant has joined the conference late and wishes to listen to the recorded conference audio content as well as view recorded conference video content, prior messaging exchanges, or application sharing histories. From an appropriate communication terminal, the conference participant may be able to initiate audio and other media sessions that are necessary for the conference by selecting a link that is associated with the conference from an electronic document, such as a calendar entry, email, or the like. The link is associated with a uniform resource locator (URL) that points to the conference system, and may be associated with information that identifies the particular conference bridge that is being used for the conference and any access information that is necessary for gaining access to the conference bridge. The audio session may be established from a user terminal from which the conference was initiated or from another telephony terminal.

Access to the recorded content may also be initiated by selecting a link that is provided to the conference participant via their communication terminal. Upon being selected, a message directed to a URL that is associated with the conference is directed to the conference system, which will process the message and effect downloading of the recorded content to the communication terminal from which access to the recorded content was requested or another communication terminal identified by the conference participant. Notably, the term “downloading” is defined to cover any method of providing access to the recorded content through streaming, file transfer, or other method. As new conference content is recorded, the newly recorded content may be provided to the communication terminal. Accordingly, the conference participant may review any past portion of the conference output from the time recording of the conference output was initiated to the present. The conference participant may control playback and review of the recorded content in any desired fashion. A media player may be used to control playback and review in traditional fashion; such control may include play, pause, rewind, fast forward, and the like.

After the conference is over, the recorded content may be archived and made accessible to the conference participant and others via the conference system, which will keep track of the location of the recorded content and conference with which it is associated. In another embodiment, the conference participant is able to readily access the recorded content by selecting the link that was previously used to initiate the audio and other media sessions that are necessary for the conference. In other words, the conference participant may use the link to join the conference, and after the conference is over and the recorded content is stored, select the same link again to initiate access to the recorded content for the conference. Upon being selected, a message directed to the URL for the link is directed to the conference system, which will process the message, recognize that the conference is over, identify the recorded content for the conference, and effect downloading of the recorded content to the communication terminal from which access to the recorded content was requested. The message or subsequent messages may include various information, such as the identification information for the conference or conference bridge as well the access information, such that the conference system can identify the recorded content and use the access information to determine whether access to the recorded content is allowed.

Notably, gaining access to the recorded content during or after the conference may require the use of various identification information in addition to the bridge information and the access information, which may represent an access code or the like. For example, when the same bridge and access information is used for different conferences, additional conference identification information may be required. The information may include specific conference identifiers, time and date information, or the like.

In yet another embodiment, the audio portion of the recorded content may be processed such that any speech content is transcribed to corresponding text, which is searchable by anyone who has access to the text. The transcribed text may be accessed and searched in any manner. Access or searching may be enabled by using the same or different link that was used to gain access to the conference. The transcribed text may be separate from or associated with the recorded content. When associated, the transcribed text may be time aligned with the recorded content, such that portions of the transcribed text that are identified in response to a search can be associated with corresponding portions of the recorded content. Accordingly, an identified portion of the transcribed text will correspond to a portion of audio content, video content, or other media aspect of the conference. Upon identifying the portion in the transcribed text, the corresponding portion of the recorded content can be made readily accessible.

These and other concepts for the various embodiments of the present invention are illustrated in association with particular examples in the following description. These examples are merely provided to illustrate the details of particular embodiments and are in no way intended to limit the broader concepts of the present invention. Prior to delving into the details of the examples, an overview of an exemplary communication environment is provided.

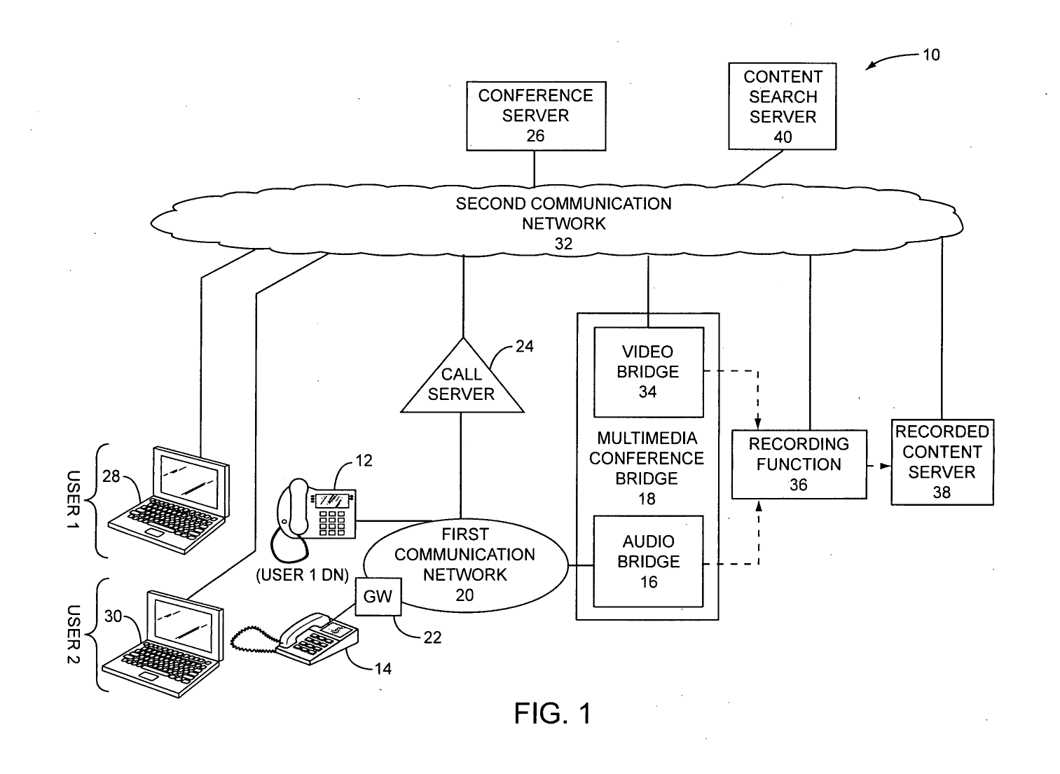

With reference to FIG. 1, a communication environment 10 is illustrated where a packet telephony terminal 12 and a Plain Old Telephone System (POTS) telephony terminal 14 are capable of joining a conference call provided by an audio bridge 16 in a multimedia conference bridge 18. The multimedia conference bridge 18 is capable of supporting various media aspects of a multimedia conference, such as video, messaging, application sharing, document pointing, and the like. However, the examples herein are primarily focused on the audio and video components of a given conference. The other media aspects may be integrated with the audio and video as desired.

Assume the packet telephony terminal 12 and the POTS telephony terminal 14 are coupled to the audio bridge 16 via a first communication network 20. As depicted, the first communication network 20 is a packet-based network, and a first gateway (GW) 22 is used to adapt the circuit-switched communications supported by the POTS telephony terminal 14 to packet-based communications for the first communication network 20. The audio bridge 16 may support packet-based communications, circuit-switched communications, or a combination thereof. Those skilled in the art will recognize that the illustrated embodiment is merely exemplary and used only to aid in understanding the broader concepts of the present invention. The communication technology and types of telephony terminals used to implement the present invention may take various forms without departing from the essence of the invention.

For a conference call, any number of participants may manually or automatically establish voice connections between their respective telephony terminals, such as the packet telephony terminal 12 or the POTS telephony terminal 14, and the audio bridge 16. Manual voice connections are established in a traditional manner by having the participants dial into the audio bridge 16, and once the voice connection is established, likely enter an access code for the particular conference. Assuming the access code is properly entered, the voice connection is joined with the other voice connections of other conference participants, and the participant is effectively placed into the conference.

To automatically establish a voice connection into the audio bridge 16, a call server 24 may be provided to initiate connections between the packet telephony terminal 12 or the POTS telephony terminal 14 and the audio bridge 16 directly or via the first gateway 22. A conference server 26, which may be integrated with or separate from the multimedia bridge 18, is adapted to instruct the call server 24 to initiate calls between the packet telephony terminal 12 or the POTS telephony terminal 14, via the first gateway 22, and the audio bridge 16. As illustrated, a first multimedia terminal 28, such as a personal computer, personal digital assistant, or the like and the packet telephony terminal 12 are used by User 1 to facilitate voice and video conferencing, respectively. Likewise, a second multimedia terminal 30 and the POTS telephony terminal 14 are used by User 2 to facilitate voice and video conferencing, respectively. In the embodiment illustrated below, the first multimedia terminals 28 effectively allows User 1 to readily join a conference call by sending an appropriate instruction to the conference server 26, which will respond by instructing the call server 24 to establish a voice connection between the associated packet telephony terminal 12 and the audio bridge 16. Multimedia terminal 30 may provide similar functionality. The multimedia terminals 28, 30 may communicate with the conference server 26 over a second communication network 32.

The conference server 26 may communicate with a video bridge 34, which may be part of the multimedia conference bridge 18 and is capable of providing the video component of a video conference in association with a voice conference provided by the audio bridge 16. Other aspects of the multimedia conference bridge 18 may facilitate application sharing, data sharing, overall conference control, and the like among the multimedia terminals 28, 30 in association with a voice or video conference. Notably, the first and second communication networks 20, 32 may be part of the same communication network or connected in a fashion to facilitate communications therebetween.

Assume User 1 is associated with the packet telephony terminal 12 and the multimedia terminal 28. To initiate the call into the audio bridge 16, the multimedia terminal 28 may send to the conference server 26 an address, such as a directory number (DN) or uniform resource locator (URL), for the packet telephony terminal 12; an address for the audio bridge 16; and an access code identifying a particular conference. The conference server 26 will instruct the call server 24 to establish a bearer path for a voice connection between the packet telephony terminal 12 and the audio bridge 16 using the addresses for the packet telephony terminal 12 and the audio bridge 16. As with the conference server 26, the call server 24 may also be integrated into the multimedia conference bridge 18.

During establishment of the bearer path between the packet telephony terminal 12 and the audio bridge 16, the conference participant may be alerted that the voice connection is being presented to the packet telephony terminal 12. When the packet telephony terminal 12 is answered, the bearer path is connected between the packet telephony terminal 12 and the audio bridge 16. Notably, the conference server 26 also provides the access code to the call server 24, which directly or indirectly delivers the access code to the audio bridge 16 in association with establishing the call into the audio bridge 16. The audio bridge 16 uses the access code to identify the conference that the voice connection between the packet telephony terminal 12 and the audio bridge 16 should join, and adds the voice connection to audio portion of the conference by connecting the bearer paths for all voice connections from the various conference participants.

To initiate the voice connection into the audio bridge 16, the conference participant may simply select a link for joining the conference in a calendar entry or electronic document, such as an email, which is hosted by an application running on the multimedia terminal 28. The link may be associated with the address for the audio bridge 16 and the access code for the conference call. In response to the link being selected by User 1, the multimedia terminal 28 may send the address for the audio bridge 16 and the access code to the conference server 26. The conference server 26 may then send a request back to the multimedia terminal 28 to obtain the address for the associated packet telephony terminal 12. If the address for the packet telephony terminal 12 is stored on the multimedia terminal 28 in a cookie or appropriate storage mechanism, the multimedia terminal 28 can automatically provide the address for the packet telephony terminal 12 to the conference server 26.

If the address for the packet telephony terminal 12 is not stored on the multimedia terminal 28 or must be selected from a list of available addresses, the multimedia terminal 28 may request the address for the packet telephony terminal 12 from User 1. For example, a window in which the address for the desired packet telephony terminal 12 is requested may be provided to User 1. The conference participant may readily respond to the request by entering or selecting the address. Once the address for the packet telephony terminal 12 is determined, the multimedia terminal 28 will provide the address to the conference server 26 for delivery to the call server 24, along with the address for the audio bridge 16 and the access code.I In a different embodiment, the functionally of the packet telephony terminal 12 could be integrated within the multimedia terminal 28.

In association with establishing the voice session into the audio bridge 16 for the conference call, the conference server 26 may also obtain video or multimedia conferencing information to allow the conference participant to join a video or other media component of the conference that hosted by the video bridge 34 or other part of the multimedia conference bridge 18. The conference server 26 may send the video or multimedia conferencing information to the multimedia terminal 28, which will use the video or multimedia conferencing information to join the conference. The video or multimedia conferencing information may include the access code for the conference or other appropriate access code to identify a corresponding component of the conference. Other conference participants may join the voice, video, or multimedia components of the conference in the same manner or through conventional techniques. In a different embodiment, the voice session may be set up directly by the user via a telephony terminal, while the multimedia terminal 28 is used to gain access via the conference server 26 to the other media associated with the conference call.

During a conference session, the audio bridge 16 supports multiple voice connections for the various participants. Audio content, including any speech content, is received over these voice connections from the various participants. In traditional fashion, the audio bridge 16 will generally analyze the audio content being received from each of the voice connections, select one or more voice connections that have the loudest or most active audio content at any given time, and process the audio content from the selected voice connections to provide conference audio content, which represents the output of the audio bridge 16. As is it is generated, the conference audio content is provided to some or all of the participants over the respective voice connections. Preferably, the audio content from a selected voice connection that is provided in the conference audio content is not fed back over the selected voice connection from which the audio content was received to avoid distracting the active speaker.

The video bridge 34 may also receive video content captured by cameras at the various conference locations. In most instances, the video content that is captured by the cameras is sent by the multimedia terminals 28, 30 to the video bridge 34, which will process the video content to generate conference video content, which is provided back to the respective multimedia terminals 28, 30 in traditional fashion. The video content provided in the conference video content at any given time may correspond to the corresponding audio content that is currently selected or may represent a composite of the video content from some or all of the conference locations.

With the present invention, the conference audio content and perhaps the corresponding conference video content and other media components are recorded by a recording function 36, which may be integrated in the multimedia bridge 18, provided in a recorded content server 38, or provided as a standalone service node. In one embodiment, the recording function 36 is capable of recording the conference audio and video content for a conference, and making the recorded portion of the conference audio and video content available for review via an appropriate communication terminal while the conference is in still in progress. In essence, the conference audio or video content may be buffered in real time, wherein any or all of the buffered content is accessible through the communication terminal at any time during the conference.

As such, a conference participant may join a conference late, and during the conference, review any or all of the components of the conference that were missed by accessing the recorded content for the conference. In this example, the focus is on recording and reviewing the audio and video content. During review of the recorded audio or video content, the conference participant may control playback of the recorded audio or video content as desired. The audio or video content may be treated and controlled as a typical media stream or file. Exemplary control includes forward and reverse scanning or skipping, pause, stop, and play.

Once the conference is complete, a recorded audio file or video file for the conference audio or video content is generated and stored in the recorded content server 38 or an associated database. After the conference is over, the recorded audio or video files may be accessed and reviewed by any authorized person, including one who was a participant in the conference, though an appropriate multimedia terminal 28, 30 or other capable telephony or media device. Again, review of the recorded audio or video content may be controlled as desired.

In an alternative embodiment, the recorded conference audio content, which may include the audio portion of any conference video content, may be made available to a content search server 40. The content search server 40 is capable of processing the conference audio content using available speech-to-text conversion techniques to generate a searchable text file, which provides text-based content that corresponds to speech content of the conference audio content. As such, the content search server 40 is capable of searching the searchable text file based on various criteria, ranging from basic keyword searches to advanced Boolean functions. Notably, the speech-to-text conversion may employ voice, speech, phoneme, or like recognition where words, phrases, or basic speech units are identified and subsequently converted to a searchable text file.

Users may submit search queries, which are applied to the text files to identify text files, locations in text files, or locations in the corresponding conference audio or video content that correspond to the search queries. In the latter case, the text files and the corresponding conference audio and video content should be associated in time, such that text in the text file is linked to corresponding portions of the recorded conference audio and video content. In response to the queries, the content search server 40 may provide a search response that identifies the text files, locations in text files, or locations in the corresponding conference audio or video content that correspond to the search queries. Additionally, all or the part of the conference audio or video that are responsive to the search query or that correspond to the search results may be provided to the user. As such, the user may have text excerpts as well as corresponding portions of the conference audio or video content that are responsive to the search query returned to them by the content search server 40.

In the following example, User 1 will join a conference using an automated “click-to-call” process, which allows User 1 to employ multimedia terminal 28 to instruct the conference server 26 to establish a voice session for audio portion of the conference between the packet telephony terminal 12 and the audio bridge 16. The conference will have multiple participants, including User 2, who is associated with the POTS telephony terminal 14 and the multimedia terminal 30. It is assumed that User 2 has already joined the conference through a voice session that was established between the POTS telephony terminal 14 and the audio bridge 16. The video portion of the conference is provided by the video bridge 34 and is supported by the appropriately equipped multimedia terminals 28, 30.

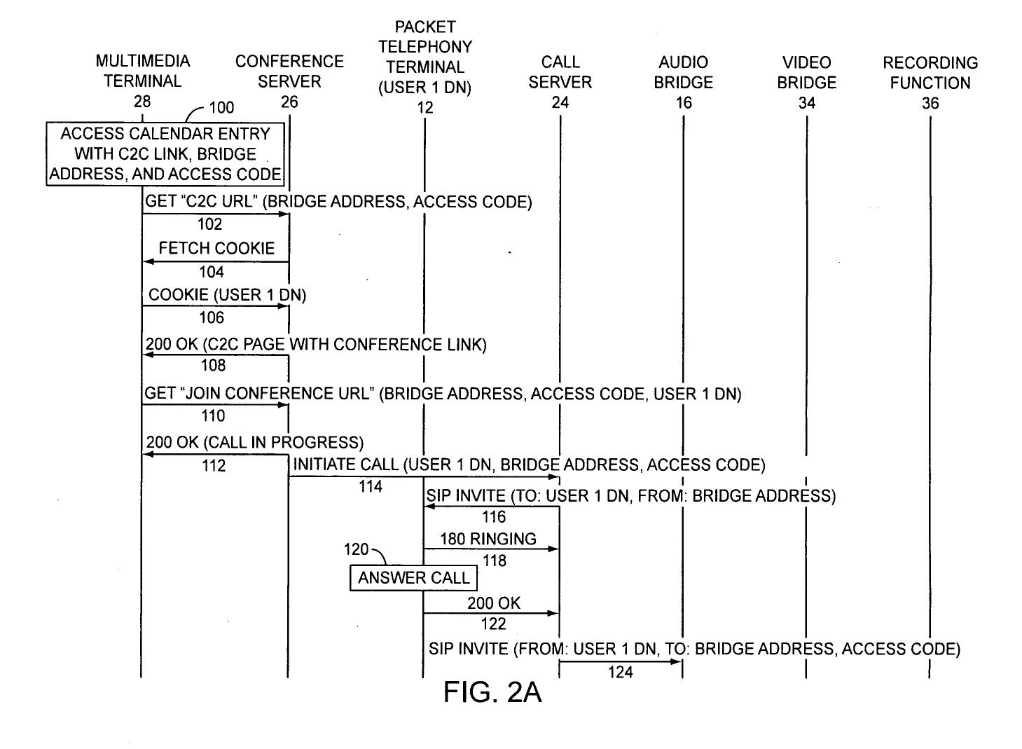

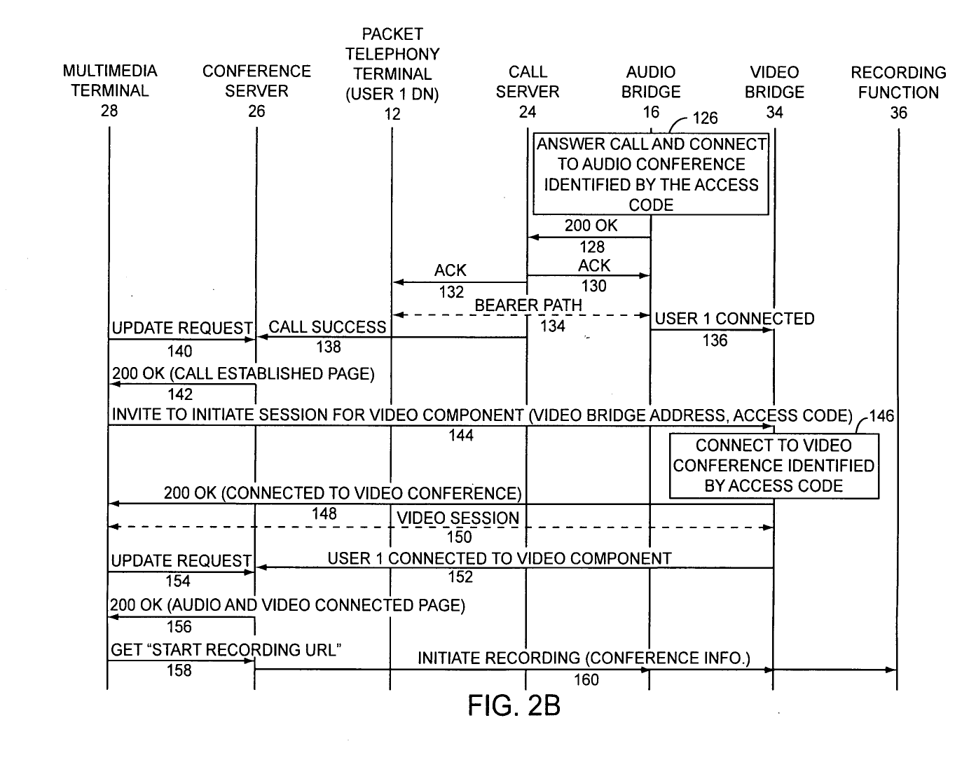

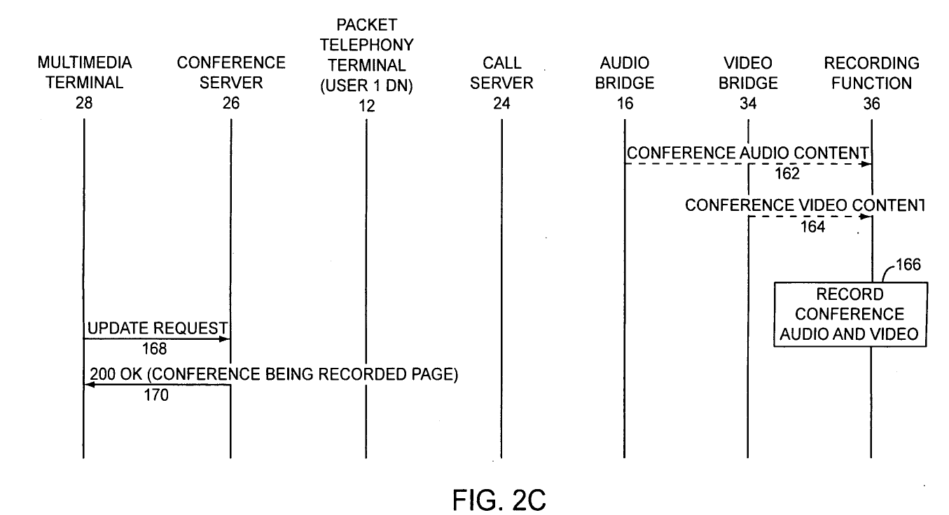

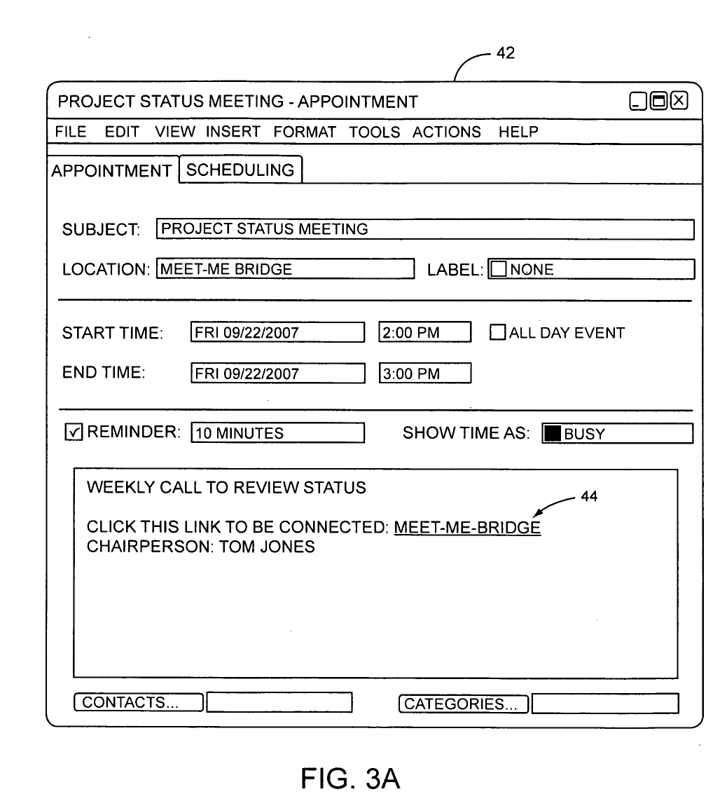

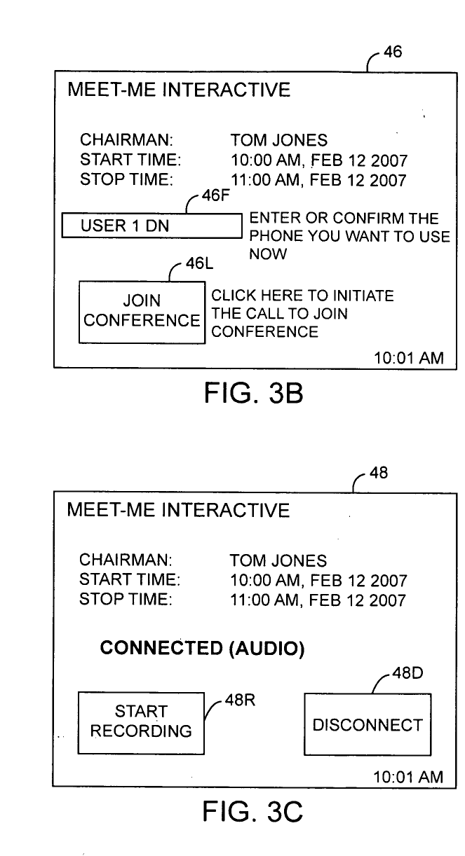

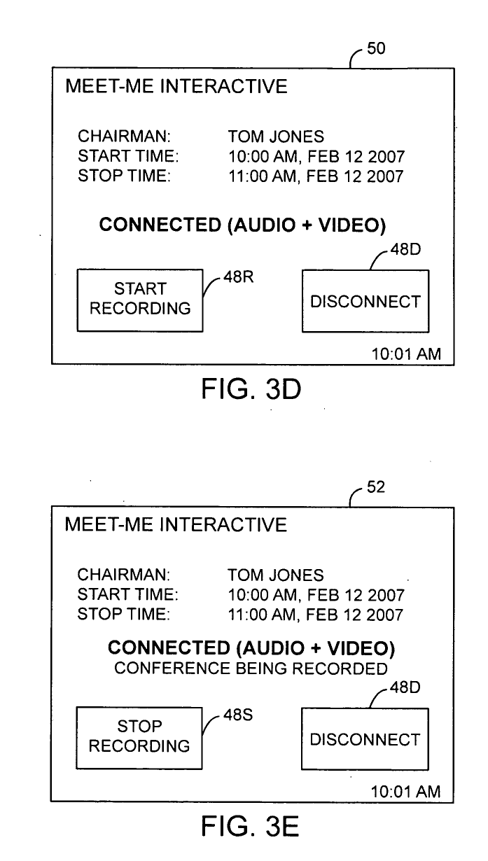

Turning now to FIGS. 2A through 2C, a communication flow is provided to illustrate how User 1, who is associated with the multimedia terminal 28 and the packet telephony terminal 12, can join a conference being hosted by the multimedia bridge 18. The communication flow also illustrates allowing User 1 to readily join a video portion of the conference, which is hosted by the video bridge 34 and associated with the conference. Initially, assume that the multimedia terminal 28 accesses a calendar entry, email, or the like for the conference (step 100). As illustrated in FIG. 3A, an exemplary calendar entry 42 may include a click-to-call (C2C) link (“meet.me.bridge”) 44, which is associated with a C2C URL that points to the conference server 26. The C2C link 44 may also be associated with a bridge address for the audio bridge 16 in particular or the multimedia bridge 18 in general, and an access code identifying the conference that the conference participant will join. When the link is selected by the conference participant, the multimedia terminal 28 will send a Hyper-Text Transfer Protocol (HTTP) GET message to the conference server 26 using the C2C URL, along with the bridge address for the audio bridge 16, and the access code for the conference (step 102). The conference server 26 may respond by attempting to fetch a cookie or like information identifying the directory number (DN) or address corresponding to the packet telephony terminal 12. As such, the conference server 26 will send a message to fetch the cookie to the multimedia terminal 28 (step 104). If such a cookie exists, the multimedia terminal 28 will respond by providing the cookie information identifying the directory number (USER 1 DN) for the packet telephony terminal 12 to the conference server 26 (step 106). The conference server 26 will then create a C2C page 46 with a conference link 46L (“JOIN CONFERENCE”) that is associated with a JOIN CONFERENCE URL and an address field 46F, as illustrated in FIG. 3B. If the directory number or address for the packet telephony terminal 12 was obtained in the fetched cookie, the directory number or address is provided in the address field 46F. Otherwise the address field 46F is left blank for User 1 to fill in once the C2C page 46 is presented to User 1.

Next, the C2C page 46 is sent to the multimedia terminal 28 in a 200 OK message (step 108). The multimedia terminal 28 will display the C2C page 46 to User 1 in a browser or other appropriate application running on the multimedia terminal 28. The C2C page 46 will present the conference link 46L to User 1, wherein when the conference link 46L is selected, a process to join the conference call via the packet telephony terminal 12 is initiated using the directory number or address provided in the address field 46F. If the address field 46F was pre-populated with the directory number from the cookie, User 1 only needs to select the conference link 46L. If the address field 46F was left blank or had the wrong directory number or address, then User 1 may enter the desired directory number or address, and then select the conference link 46L.

Once the conference link is selected, the multimedia terminal 28 will send an HTTP GET message to the conference server 26 using the JOIN CONFERENCE URL that is associated with the conference link 46L (step 110). The HTTP GET message may include the bridge address for the audio bridge 16, the access code, and the directory number for the packet telephony terminal 12. The conference server 26 will respond to the multimedia terminal 28 with a 200 OK message indicating that a call into the audio bridge 16 is in progress (step 112), and the multimedia terminal 28 may update the C2C page 46 to indicate the same (not shown). The conference server 26 will then provide an Initiate Call message to the call server 24 to initiate a voice session between the packet telephony terminal 12 and the audio bridge 16 (step 114). The Initiate Call message will include the directory number (USER 1 DN) for the packet telephony terminal 12 and the bridge address for the audio bridge 16 for the call server 24 to use in establishing the voice session between the packet telephony terminal 12 and the audio bridge 16. Notably, the Initiate Call message also provides the access code to the call server 24, which may subsequently deliver the access code to the audio bridge 16 to gain access the conference once the voice session is established, as illustrated below.

In response to the Initiate Call message, the call server 24 will take the necessary steps to establish a bearer path between the packet telephony terminal 12 and the audio bridge 16. In this example, the Session Initiation Protocol (SIP) is used to initiate a packet-based communication session, representing a bearer path, between the packet telephony terminal 12 and the audio bridge 16. Those skilled in the art will recognize that circuit-switched bearer paths may also be provided between other gateways or circuit-switched devices to facilitate a bearer path into the audio bridge 16 for the conference call. To establish the bearer path, the call server 24 may send a SIP Invite message toward the packet telephony terminal 12, wherein the SIP Invite message is configured to indicate that a call is being initiated to a directory number (USER 1 DN) associated with the packet telephony terminal 12 from the bridge address of the audio bridge 16 (step 116). The packet telephony terminal 12 will alert User 1 that a call is being received by ringing or the like and send a 180 Ringing message back to the call server 24 (step 118). Once User 1 answers the call (step 120), the packet telephony terminal 12 will send a 200 OK message back to the call server 24 (step 122).

The call server 24 will also send a SIP Invite message to the audio bridge 16 to indicate that a session is being initiated to the audio bridge 16 using the bridge address and the directory number (USER 1 DN) for the packet telephony terminal 12 (step 124). The access code for the conference call may be provided to the audio bridge 16 in the SIP Invite message. The audio bridge 16 may then answer the call and connect to the audio conference identified by the access code (step 126), as well as respond to the SIP Invite message by providing a 200 OK message back to the call server 24 (step 128). The call server 24 will acknowledge the 200 OK message received from the audio bridge 16 by sending an Acknowledgment message (ACK) back to the audio bridge 16 (step 130). The call server 24 will respond to the 200 OK message received from the packet telephony terminal 12 by sending an Acknowledgement message to the packet telephony terminal 12 (step 132). During this message exchange, the Session Description Protocol (SDP) provided within the SIP message exchange has provided sufficient information between the packet telephony terminal 12 and the audio bridge 16 to establish a bearer path, or voice session, between the packet telephony terminal 12 and the audio bridge 16 (step 134). Once the voice session is established, the audio bridge 16 may send a message to the associated video bridge 34 to indicate that User 1 is connected to the conference via a voice session (step 136).

The call server 24 may send a Call Success message back to the conference server 26 to indicate that the conference participant is successfully engaged in the conference call via the packet telephony terminal 12 (step 138). The conference server 26 may maintain the relative status of the conference participants with respect to the conference. The multimedia terminal 28 may send systematic Update Request messages to the conference server 26 to obtain conference-related updates or instructions (step 140). If the video bridge 34 is providing video conferencing functionality in association with the conference call, the conference server 26 may retrieve a corresponding video bridge address for the conference call, and a corresponding access code, which may be the same access code used for the conference. In response to the Update Request message, the conference server 26 may generate a call established page 48, which indicates that the audio portion of the conference is connected and includes any desired control links for controlling different aspects of the conference, as illustrated in FIG. 3C. The illustrated control links include a “start recording” control link 48R and a “disconnect” control link 48D. When selected, the “start recording” control link 48R will trigger recording of the audio or video components of the conference by the recording function 36 and the “disconnect” control link 48D will trigger disconnecting from the conference. The call established page may also provide the video bridge address and access code for the conference to the multimedia terminal 28. The call established page is then sent to the multimedia terminal 28 (step 142).

Assuming the conference has a video component, the multimedia terminal 28 may generate an Invite to initiate a session for the video component of the conference and send the Invite to the conference server 26, which will forward the Invite to the video bridge 34 (step 144). The Invite may include the video bridge address and the access code for the conference. The video bridge 34 will process the Invite to establish the video session for the video component of the conference and connect the video session to the appropriate video conference that is identified by the access code (step 146). The Invite will also include the necessary information for the video bridge 34 to deliver conference video content to the multimedia terminal 28 for the video session. The video bridge 34 will provide a 200 OK message to the conference server 26, which will forward the 200 OK message to the multimedia terminal 28 (step 148). The 200 OK message will provide the necessary information for the multimedia terminal 28 to provide video content to the video bridge 34 for the video conference. At this point, a bidirectional video session is established between the multimedia terminal 28 and the video bridge 34 (step 150), and the video session is connected to the video portion of the conference. Once connected into the video conference, the video bridge 34 may provide a message to the conference server 26 to indicate that User 1 is connected to the video portion of the conference (step 152).

As indicated above, the multimedia terminal 28 may periodically send update requests to the conference server 26 (step 154). Once the video component of the conference is established for User 1, the conference server 26 may provide an audio and video connected page to the multimedia terminal 28 in a 200 OK message (step 156). The audio and video connected page 50, as illustrated in FIG. 3D, may indicate that User 1 is connected to the conference through both audio and video components. As depicted, the audio and video connected page 50 may represent an updated version of the call established page 48, which includes the start recording and disconnect control links 48R and 48D.

Once the audio and video connected page is displayed to User 1, User 1 has the option to select the start recording control link 48R to trigger recording of the audio and video components of the conference. Assuming the start recording control link 48R is associated with a START RECORDING URL, selecting the start recording control link 48R will result in the multimedia terminal 28 sending a GET message with the START RECORDING URL toward the conference server 26 (step 158). The conference server 26 may take the necessary steps to instruct the audio bridge 16, video bridge 34, and perhaps the recording function 36, to initiate recording of the conference audio and video content that is output by the audio bridge 16 and the video bridge 34, respectively (step 160). Notably, the conference audio and video content may be provided in separate streams to the recording function 36 or may be combined into a single media stream within the multimedia bridge 18. If different streams are provided to the recording function 36, the recording function 36 may store the conference audio and video content in separate files or integrate them to provide a composite file containing the conference audio and video content. In this example, assume the audio bridge 16 provides the conference audio content to the recording function 36 (step 162), and the video bridge 34 provides the conference video content (step 164) in separate streams, which are provided to the recording function 36. The recording function 36 will record the conference audio and video content as composite media in a single file (step 166).

When the multimedia terminal 28 sends the next update request to the conference server 26 (step 168), the conference server 26 may generate a conference being recorded page 52, such as that illustrated in FIG. 3E and provide it to the multimedia terminal 28 in a 200 OK message (step 170). Notably, the conference being recorded page 52 may include additional control links, such as a stop recording control link 48S. The stop recording control link 48S is associated with a STOP RECORDING URL, wherein when the stop recording control link 48S is selected, recording of the conference audio and video content is stopped.

At this point, the recording function 36 is recording the conference audio and video content. Preferably, the conference audio and video content that has been recorded is buffered and made available to the multimedia terminal 28, such that any portion or all of the recorded conference audio and video content may be provided to the multimedia terminal 28 while the conference is in progress and while additional conference audio and video content for the conference is being recorded. As such, User 1 may access the recorded conference audio and video content and begin listening to the recorded conference audio and video content at any point, and navigate forward and backwards within the conference audio and video content in any desired manner. As new conference audio and video content is recorded, it can be streamed to the multimedia terminal 28, and buffered by the multimedia terminal 28, such that User 1 is continuously being provided the recorded conference audio and video content while being able to access any portion thereof. Although various techniques are available for making the recorded conference audio and video content available to the multimedia terminal 28, the recording function 36 may download the recorded conference audio and video content to the multimedia terminal 28 for buffering, and continue to stream the conference audio and video content that is being recorded. As additional conference audio and video content is recorded and streamed to the multimedia terminal 28, the multimedia terminal 28 will continue to buffer the streaming conference audio and video content and make it available to User 1.

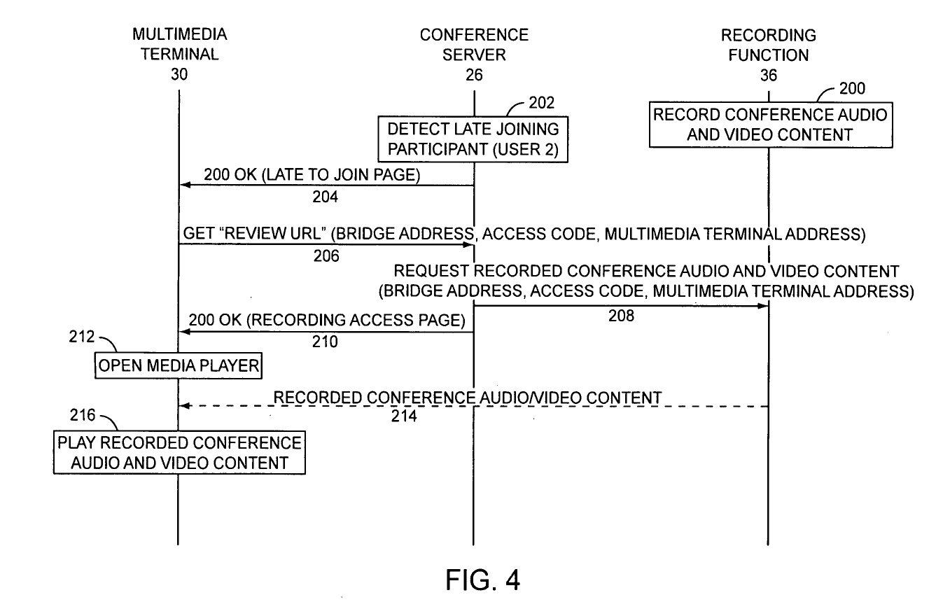

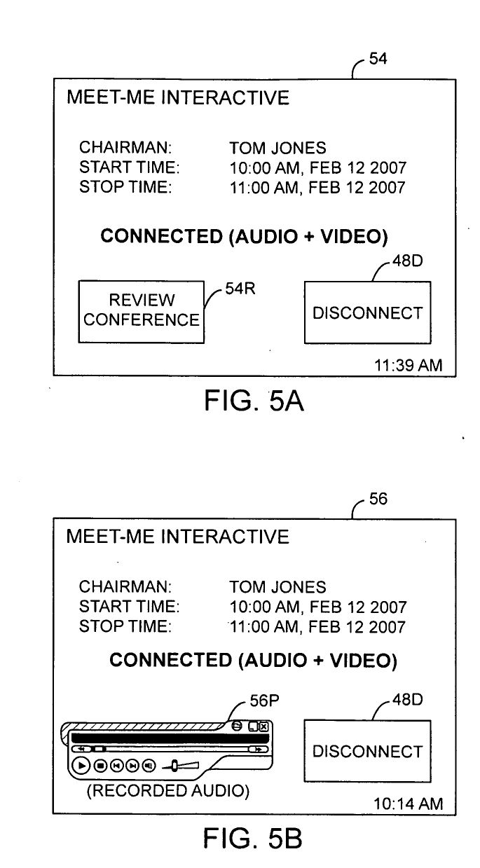

With reference to FIG. 4, an exemplary process for making conference audio and video content available for review while the conference is still in progress is provided according to one embodiment of the present invention. In this example, assume that the conference is in progress and the conference audio and video content is being recorded by the recording function 36 (step 200). Further assume that the conference server 26 detects a late joining participant who has joined the conference after the conference has started, and in particular, after the start of recording the conference audio and video content (step 202). Further assume that the late joining participant is User 2, who is connected to the audio bridge 16 via the POTS telephony terminal 14 and is controlling the conference via their multimedia terminal 30. Upon being joined into the conference, the conference server 26 may provide a late to join page in a 200 OK message to the multimedia terminal 30 (step 204). An exemplary late to join page 54 is illustrated in FIG. 5A. The late to join page 54 may indicate that the user is connected to the audio and video components of the conference, as well as provide various control links. As depicted, a “review conference” control link 54R is provided in association with the “disconnect” control link 48D. The review conference link 54R may be associated with a REVIEW URL, wherein when the review conference control link 54R is selected, the multimedia terminal 30 will send a GET message with the REVIEW URL to the conference server 26 (step 206). The GET message may include the bridge address, access code, and the address for the multimedia terminal 30, such that the conference server 26 may send a request to the recording function 36 to access the recorded portion of the conference audio and video content that is associated with the identified bridge address and access code (step 208).

While the recorded conference audio and video content is being requested, the conference server 26 may provide a recording access page 56 in a 200 OK message to the multimedia terminal 30 (step 210), as illustrated in FIG. 5B. In response to receiving and displaying the page, the multimedia terminal 30 may open a media player in preparation for processing the recorded conference audio and video content that will be received from the recording function 36 (step 212). The media player may be opened in a separate application or in association with the browser. As depicted, the media player is opened in association with the browser, and a control panel 56P for the media player is presented within the recording access page 56. Accordingly, when the recording function 36 begins streaming the recorded conference audio and video content to the multimedia terminal 30 using the address provided in the request (step 214), the media player may begin buffering the incoming stream such that User 2 may begin playback of the recorded conference audio and video content as soon as there is a sufficient amount of the recorded conference audio and video content received from the recoding function 36 (step 216).

As with any type of streaming media, playback of the portion of the conference audio and video content that has been received by the multimedia terminal 30 may be controlled in any fashion by User 2. For example, User 2 may elect to simply begin playback of the recorded conference audio and video content at the beginning of the conference, or may scan forward and backward through the recorded conference audio and video content as desired. Once all of the recorded conference audio and video content is downloaded to the multimedia terminal 30, the recording function 36 may stream live conference audio and video content to the multimedia terminal 30, which will buffer the live conference audio and video content along with the previously received recorded conference audio and video content. As such, User 2 has access to the conference audio and video content from when recording started through the present time. The recording function 36 will continue to record the live conference audio and video content, and when the conference is over, will generate one or more media files and present them, if desired, to the recorded content server 38.

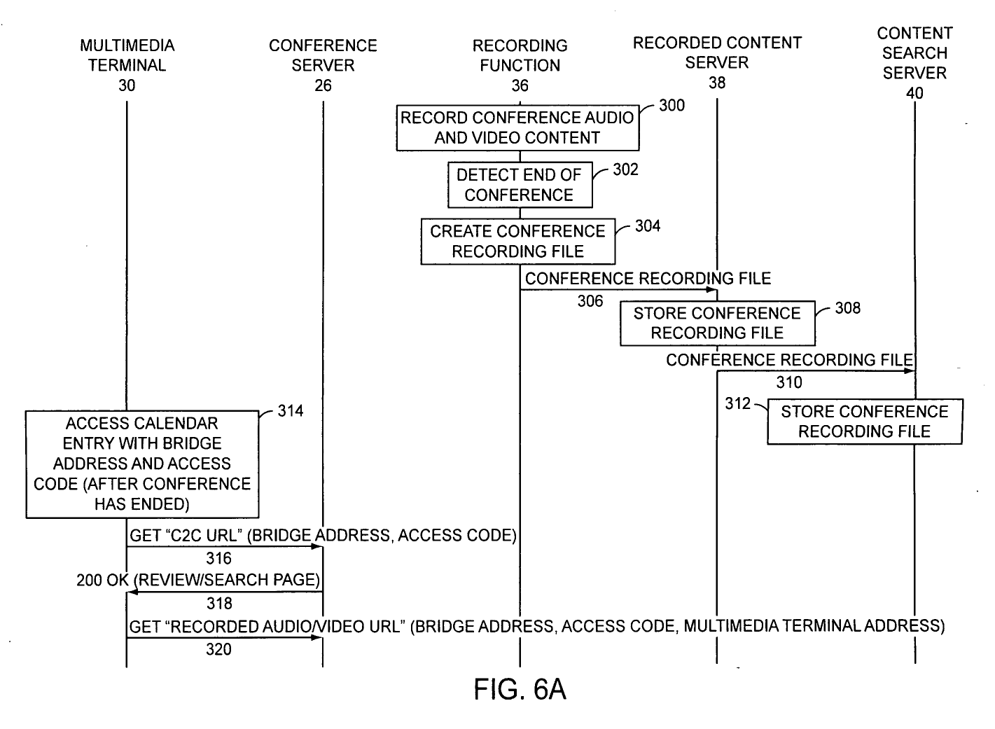

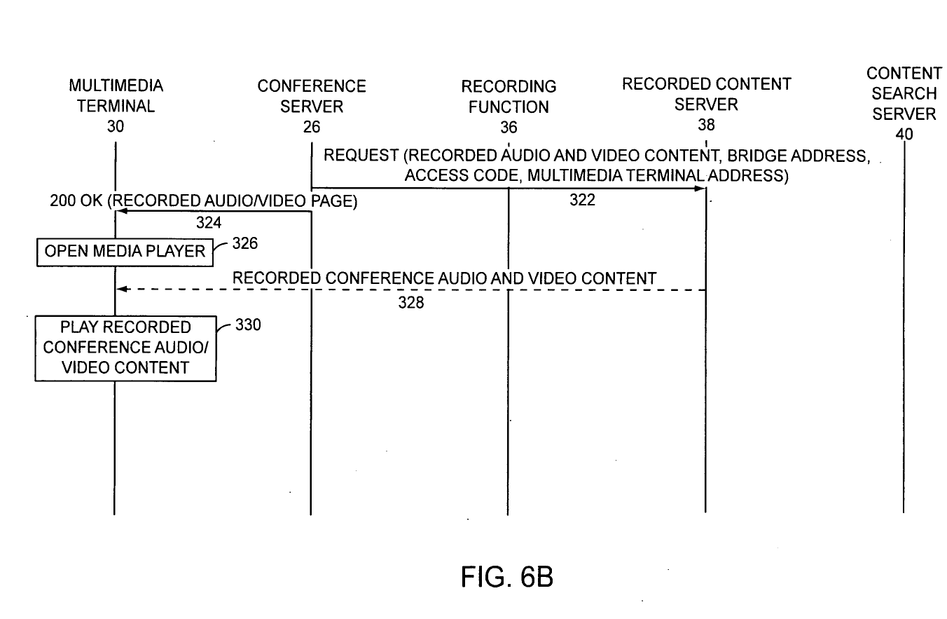

In addition to reviewing conference audio and video content that has been recorded during a conference, any of the participants as well as others who are not participants in the conference may access recorded audio and video content for a conference through the recorded content server 38. With reference to FIG. 6, an exemplary process is provided to illustrate a scenario wherein User 2 accesses recorded conference audio and video content for a conference after the conference is over via their multimedia terminal 30 and the recorded content server 38. Initially, assume the recording function 36 is recording the conference audio and video content for a conference (step 300), and when the end of the conference is detected (step 302) will create a conference recording file (step 304) and provide it to the recorded content server 38 (step 306). The recording content server 38 will store the conference recording file, preferably in association with the access code and perhaps the bridge address associated with the conference (step 308). Any other conference identifier may be provided with the conference recording file to allow others to subsequently access the conference recording file once it has been stored. The conference recording file may be stored in the recorded content server 38 or in an associated database. At any point after the conference recording file has been created and stored on the recorded content server 38, the content search server 40 may gain access to the conference recording file (step 310), and if desired, store the conference recording file (step 312) for further processing, which will be described further below.

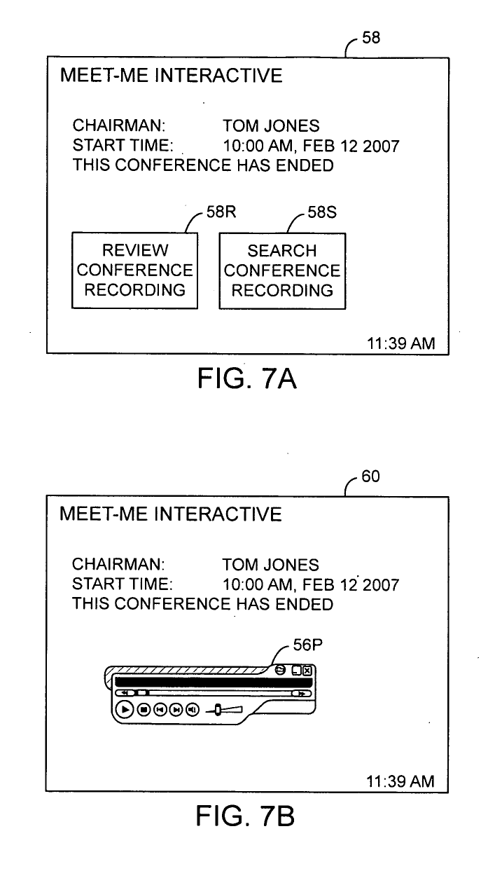

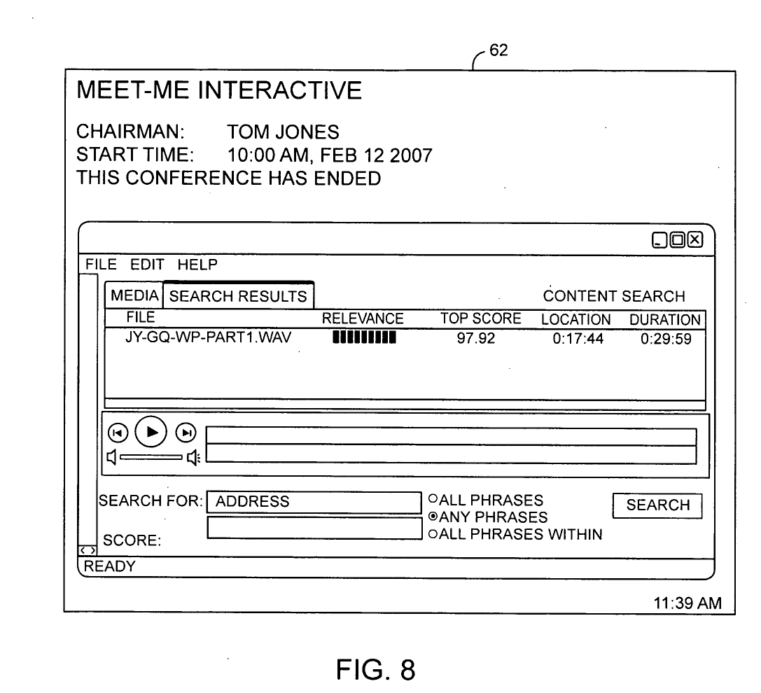

At some point after the conference is over and the corresponding conference audio and video content has been stored in a conference recording file at the recorded content server 38, User 2 may access a calendar entry that was associated with the conference (step 314). The calendar entry may be the same as or similar to that provided in FIG. 3A, from which User 1 initiated entry into the conference. Although any technique may be used to gain access to the conference recording file that is stored on the recorded content server 38, in this example, User 2 may select the C2C link 44 in the calendar entry 42, which will trigger the multimedia terminal 30 to send a GET message with the C2C URL to the conference server 26 (step 316). The GET message will include the bridge address and access code that was associated with the C2C link 44 and used to identify the conference. The conference server 26 will recognize that the conference associated with the bridge address, access code, or other conference identifier has expired, and will send a review/search page 58 such as that illustrated in FIG. 7A, in a 200 OK message to the multimedia terminal 30 (step 320). The review/search page 58 may include a review conference recording control link 58R and a search conference recording control link 58S. The review conference recording control link 58R may be associated with a RECORDED AUDIO/VIDEO URL, wherein when the review conference recording control link 58R is selected, the multimedia terminal 30 will send a GET message including the RECORDED AUDIO/VIDEO URL to the conference server 38 (step 320). The GET message may include the bridge address, access code, and the multimedia address for the multimedia terminal 30. The conference server 26 will send a request for the recorded audio and video content that is associated with the conference corresponding to the identified bridge address and access code (step 322). The request may include the multimedia terminal address for the multimedia terminal 30, such that the recorded content server 38 may use the multimedia terminal address to deliver the recorded conference audio and video content to the multimedia terminal 30.

Meanwhile, the conference server 26 may provide a recorded audio/video page 60, such as that illustrated in FIG. 7B, to the multimedia terminal 30 in a 200 OK message (step 324). The recorded audio/video page 60 may indicate that the conference has ended. Further, the multimedia terminal 30 may open the media player and present the control panel 56P for the media player along with the recorded audio/video page 60 (step 326). The recorded content server 38 will identify the recorded conference audio and video content that is being requested and provide it to the multimedia terminal 30 using the corresponding multimedia terminal address (step 328). The media player will receive the recorded conference audio and video content and allow User 2 to control playback of the recorded conference audio and video content as desired (step 330).

In addition to being able to review the recorded audio and video content, User 2 may access the content search server 40 to gain access to and potentially search a transcript or other text-based representation of the conference audio content. Either in response to a search or upon receiving the conference recording file for a conference, the content search server 40 may effectively transcribe the speech content represented in the conference audio content using an available speech-to-text conversion process to provide a searchable text file of the conference audio content. Accordingly, the multimedia terminal 30 may generate and submit a search query to the content search server 40. The content search server may use the search query to search one or more of the conference recording files. The search query may be limited to a particular conference recording file or may be general to multiple conference recording files. As such, the content search server 40 may identify multiple conference recording files that correspond to different conferences, which correspond to a given search query. Alternatively, the search may be limited to a particular conference recording file, which is associated with a particular conference. Users may submit search queries that are applied to the conference recording files to identify locations within the conference recording files, or locations in the corresponding conference audio and video content, based on the text-based search. In the latter instance, the content of the conference recording files are time-aligned with the conference audio and video content. As such, a section of the conference recording file that satisfies a search query may be used to identify a corresponding portion of the conference audio and video content. Those skilled in the art will recognize various ways to search and provide search results in light of the teachings of the present invention.

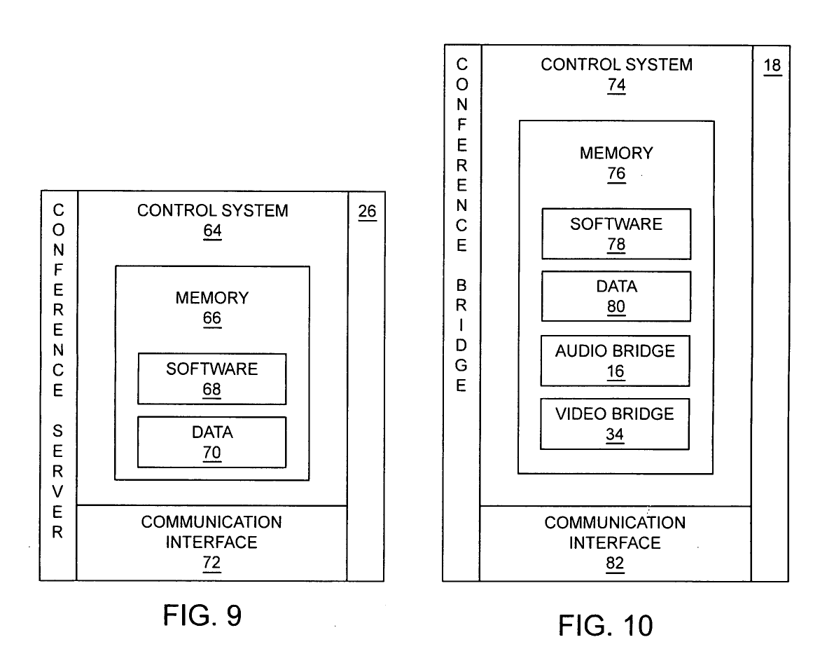

Turning now to FIG. 9, a block representation of a conference server 26 is illustrated. The conference server 26 will include a control system 64 having sufficient memory 66 for the requisite software 68 and data 70 to operate as described above. The control system 64 is associated with a communication interface 72 to facilitate communications with the various entities in the communication environment 10, as described above. The functionality of the conference server 26 may be provided in the multimedia conference bridge 18 as well as be considered part of the overall conference system.

Turning now to FIG. 10, a block representation of a multimedia conference bridge 18 is illustrated. The multimedia conference bridge 18 will include a control system 74 configured to operate and control the audio bridge 16 and video bridge 34 as well as support any other media conference function, such as application sharing, messaging exchanges, and the like. The control system 74 will have sufficient memory 76 for the requisite software 78 and data 80 to operate as described above. The control system 74 is associated with at least one communication interface 82 to facilitate communications with the various entities in the communication environment 10, as described above. In certain embodiments, the multimedia conference bridge 18 will include the recording function 36, and provide the functionality of the recorded content server 38.

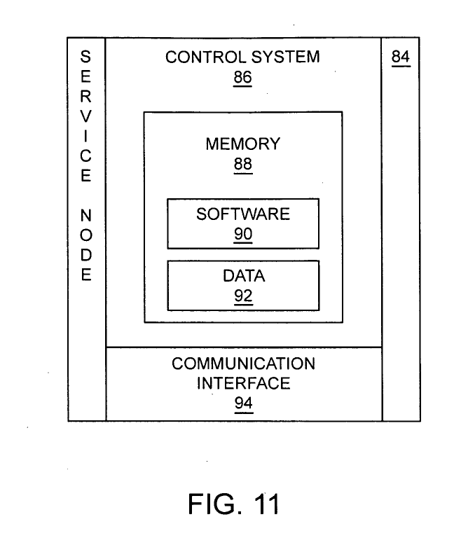

Turning now to FIG. 11, a block representation of a service node 84 is illustrated. The service node 84 will include a control system 86 having sufficient memory 88 for the requisite software 90 and data 92 to operate as described above. The service node 84 may provide the functionality of any one or more of the call server 24, conference server 26, recording function 36, recorded content server 38, and the content search server 40. The control system 86 is associated with a communication interface 94 to facilitate communications with the various entities in the communication environment 10 to facilitate the functionality provided.

Those skilled in the art will recognize improvements and modifications to the preferred embodiments of the present invention. All such improvements and modifications are considered within the scope of the concepts disclosed herein and the claims that follow.

What is claimed is:

1. A method for providing access to recorded conference content comprising:
receiving a first message from a first user terminal of a first user during a conference, wherein the first user is one of a plurality of participants who are party to the conference, and an audio portion of the conference is supported by an audio bridge, which outputs conference audio content that represents the audio portion of the conference;
recording the conference audio content during the conference to generate recorded conference audio content; and
in response to the first message, providing the recorded conference audio content to the first user terminal such that the first user may effect and control playback of the recorded conference audio content on the first user terminal while the conference is in progress.

2. The method of claim 1 further comprising providing the conference audio content to the first user terminal or other telephony terminal of the first user in real time apart from providing the recorded audio content to the first user terminal, and wherein the first user receives the conference audio content in real time via the first user terminal or the other telephony terminal in addition to receiving the recorded conference audio content for review.

3. The method of claim 1 wherein as additional conference audio content becomes available while the conference progresses, additional recorded conference audio content is recorded and provided to the first user terminal.

4. The method of claim 1 wherein the recorded conference audio content includes the conference audio content from a time when recording of the conference audio was initiated to substantially a present time.

5. The method of claim 1 wherein the first message provides access information associated with the conference, and further comprising, prior to providing the recorded conference audio content to the first user terminal, processing the access information to determine whether to provide the recorded audio conference content to the first user terminal.

6. The method of claim 5 wherein the access information comprises an access code that was used to allow the first user to gain access to the conference.

7. The method of claim 1 wherein the first message provides bridge identification information that identifies the conference and further comprising selecting the recorded conference audio content based on the bridge identification information.

8. The method of claim 1 wherein the first message was generated in response to the first user selecting a first control link, which is displayed on the first user terminal.

9. The method of claim 8 wherein the first message was generated in response to the first user selecting the first control link on a first web page, which is displayed on the first user terminal.

10. The method of claim 9 further comprising generating the first web page with the first control link and sending the first web page to the first user terminal.

11. The method of claim 10 wherein the first web page includes at least a second control link, which when selected generates a second message to facilitate control of at least one aspect of the conference other than retrieving the recorded conference audio content.

12. The method of claim 1 further comprising, upon receiving the first message, determining that the conference is still in progress.

13. The method of claim 1 further comprising:
prior to the first user joining the conference, receiving from the first user terminal a second message including an address and access information for the conference from the first user terminal of the first user, wherein the second message is indicative of the first user desiring to gain access to the conference; and
effecting establishment of a voice session for the first user with the audio bridge using the address and access information to the conference associated with the access information, wherein the second message was generated in response to the first user selecting an initiation link, which is displayed on the first user terminal.

14. The method of claim 1 wherein a voice session providing the audio portion of the conference for the first user is established between the audio bridge and a second user terminal that is associated with the first user.

15. The method of claim 1 wherein the audio bridge supports a plurality of voice session with the plurality of participants and provides an audio conference function to facilitate an audio conference among the plurality of participants via the plurality of voice sessions.

16. The method of claim 1 wherein:
a video portion of the conference is supported by a video bridge, which outputs conference video content that represents the video portion of the conference;
the conference video content is recorded in association with the conference audio content to provide recorded conference video content; and
in response to the first message, the recorded conference video content is provided with the recorded conference audio content to the first user terminal.

17. A method for providing access to recorded conference content comprising:
receiving a first message from a first user terminal of a first user after a conference has ended, wherein:
an audio portion of the conference was recorded and stored as recorded conference audio content; and
the first message was sent in response to the first user selecting a first link, which was displayed on the first user terminal; and
in response to the first message, providing the recorded conference audio content to the first user terminal, such that the first user may effect and control playback of the recorded conference audio content on the first user terminal.

18. The method of claim 17 wherein the first link was displayed to the user in a calendar entry or email associated with the conference.

19. The method of claim 17 further comprising recording the conference audio content during the conference to generate recorded conference audio content.

20. The method of claim 17 wherein the first message provides access information associated with the conference, and further comprising, prior to providing the recorded conference audio content to the first user terminal, processing the access information to determine whether to authorize access to the recorded conference audio content by the first user terminal.

21. The method of claim 20 wherein the first user was an invited participant in the conference and the access information was or could have been used to allow the first user to gain access to the conference.

22. The method of claim 21 further comprising:
prior to the conference ending and the first user joining the conference, receiving from the first user terminal a second message including an address and the access information for the conference from the first user terminal of the first user, wherein the second message is indicative of the first user desiring to gain access to the conference and generated in response to the first user selecting an initiation link, which is displayed on the first user terminal; and
effecting establishment of a voice session for the first user with the audio bridge using the address and access information to the conference associated with the access information.

23. The method of claim 22 wherein the initiation link is the first link.

24. The method of claim 22 wherein the voice session providing the audio portion of the conference for the first user is established between the audio bridge and a second user terminal that is associated with the first user.

25. The method of claim 17 further comprising:
prior to the conference ending and the first user joining the conference, receiving from the first user terminal a second message including an address and the access information for the conference from the first user terminal of the first user, wherein the second message is indicative of the first user desiring to gain access to the conference and generated in response to the first user selecting the first link; and
effecting establishment of a voice session for the first user with the audio bridge using the address and access information to the conference associated with the access information.

26. The method of claim 17 wherein the first message provides bridge identification information that identifies the conference and further comprising selecting the recorded conference audio content based on the bridge identification information.

27. The method of claim 17 wherein the first message provides access information associated with the conference, and further comprising, prior to providing the recorded conference audio content to the first user terminal, processing the access information to determine whether to provide the recorded conference audio content to the first user terminal.

28. The method of claim 17 further comprising:
accessing the recorded conference audio content; and
generating a text-based file corresponding to speech content of the recorded conference audio content.

29. The method of claim 28 further comprising:
receiving a search query from at least one user;
processing the text-based file to identify information in the text-based file that corresponds to the search query; and
providing to the at least one user the information in the text-based file that corresponds to the search query.

30. A system for providing access to recorded conference content comprising:
at least one communication interface; and
a control system associated with the at least one communication interface and adapted to:
receive a first message from a first user terminal of a first user during a conference, wherein the first user is one of a plurality of participants who are party to the conference, and an audio portion of the conference is supported by an audio bridge, which outputs conference audio content that represents the audio portion of the conference;
record the conference audio content during the conference to generate recorded conference audio content; and
in response to the first message, provide the recorded conference audio content to the first user terminal such that the first user may effect and control playback of the recorded conference audio content on the first user terminal while the conference is in progress.

31. A system for providing access to recorded conference content comprising:
at least one communication interface; and
a control system associated with the at least one communication interface and adapted to:
receive a first message from a first user terminal of a first user after a conference is complete, wherein:
an audio portion of the conference was recorded and stored as recorded conference audio content, and
the first message was sent in response to the first user selecting a first link, which was displayed on the first user terminal; and
in response to the first message, provide the recorded conference audio content to the first user terminal such that the first user may effect and control playback of the recorded conference audio content on the first user terminal.
